(19) United States
(12) Patent Application Publication
(10) Pub. No.: US 2020/0393584 A1
(43) Pub. Date: Dec. 17, 2020

(54) Mono and Dipole Acoustic Projector

(71) Applicant: PGS Geophysical AS, Oslo (NO)

(72) Inventors: Mattias Oscarsson-Nagel, Oslo (NO); Øystein Traetten, Oslo (NO)

(73) Assignee: PGS Geophysical AS, Oslo (NO)

(21) Appl. No.: 16/861,960

(22) Filed: Apr. 29, 2020

Related U.S. Application Data
(60) Provisional application No. 62/860,141, filed on Jun. 11, 2019.

(51) Int. Cl. G01V 1/145; G01V 1/38

(52) U.S. Cl. CPC G01V 1/145; G01V 1/3861

(57) ABSTRACT

Disclosed are apparatuses, systems, and methods for use of an acoustic projector. An embodiment discloses an acoustic projector comprising a fixed plate; a first bender plate coupled to a first side of the fixed plate; a second bender plate coupled to a second side of the fixed plate, opposite to the first side; a first driver coupled to the first side of the fixed plate and to the first bender plate to oscillate the first bender plate; and a second driver coupled to the second side of the fixed plate and to the second bender plate to oscillate the second bender plate.

### CROSS-REFERENCE TO RELATED APPLICATIONS

The present application claims the benefit of U.S. Provisional Application No. 62/860,141, filed Jun. 11, 2019, entitled “Mono and Dipole Acoustic Projector,” the entire disclosure of which is incorporated herein by reference.

### BACKGROUND

Techniques for marine surveying include marine seismic surveying, in which geophysical data may be collected from below the Earth's surface. Marine seismic surveying has applications in mineral and energy exploration and production to help identify locations of hydrocarbon-bearing formations. Marine seismic surveying typically may include towing a seismic source below or near the surface of a body of water. One or more streamers may also be towed through the water by the same or a different vessel. The streamers are typically cables that include a plurality of sensors disposed thereon at spaced apart locations along the length of each cable. Some seismic surveys locate sensors on ocean bottom cables or nodes in addition to, or instead of, streamers.

The sensors may be configured to generate a signal that is related to a parameter being measured by the sensor. At selected times, the seismic source may be actuated to generate, for example, acoustic energy that travels downwardly through the water and into the subsurface formations. Acoustic energy that interacts with interfaces, generally at the boundaries between layers of the subsurface formations, may be returned toward the surface and detected by the sensors on the streamers. The detected energy may be used to infer certain properties of the subsurface formations and interfaces, such as structure, mineral composition and fluid content, thereby providing information useful in the recovery of hydrocarbons.

### BRIEF DESCRIPTION OF THE DRAWINGS

These drawings illustrate certain aspects of some of the embodiments of the present disclosure and should not be used to limit or define the disclosure.

FIG. 1 illustrates an example embodiment of a marine seismic survey system using a marine seismic vibrator;

FIG. 2 illustrates an example embodiment of an acoustic projector;

FIG. 3 illustrates another example embodiment an acoustic projector;

FIG. 4A illustrates an example embodiment of generation of acoustic waves by an acoustic projector operating in a first mode;

FIG. 4B illustrates another example embodiment of generation of acoustic waves by an acoustic projector operating in a second mode;

FIG. 5 illustrates another example embodiment an acoustic projector; and

FIG. 6 illustrates an example of a marine survey system including the acoustic projector towed in a sled.

### DETAILED DESCRIPTION

Embodiments may be directed to acoustic projectors and associated methods. At least one embodiment may be directed to an acoustic projector operable in a monopole mode and a dipole mode.

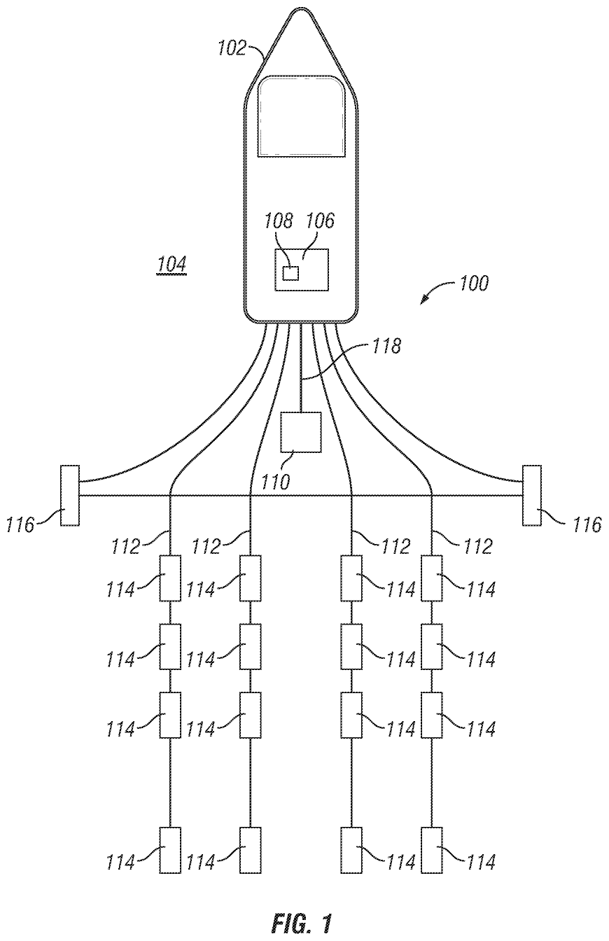

FIG. 1 illustrates a marine seismic survey system 100 in accordance with example embodiments. Marine seismic survey system 100 may include a survey vessel 102 that moves along the surface of a body of water 104, such as a lake or ocean. The survey vessel 102 may include equipment, shown generally at 106 and collectively referred to herein as a “recording system.” The recording system 106 may include devices (none shown separately) for detecting and making a time indexed record of signals generated by each of seismic sensors (explained further below) and for actuating an acoustic projector 110 at selected times. The recording system 106 may also include a control system 108 for controlling operation of the acoustic projector 110. The control system 108 may be a component of the recording system 106 as shown on FIG. 1 or the control system 108 may be a separate component. The recording system 106 may also include devices (none shown separately) for determining the geodetic position of the survey vessel 102 and the various seismic sensors.

As illustrated, the survey vessel 102 may tow sensor streamers 112. The sensor streamers 112 may be towed in a selected pattern in the body of water 104 by the survey vessel 102 or a different vessel. As illustrated, the sensor streamers 112 may be laterally spaced apart behind the survey vessel 102. “Lateral” or “laterally,” in the present context, means transverse to the direction of the motion of the survey vessel 102. Towing equipment 116 may be used spread the sensors streamers 112 laterally apart from one another. Suitable towing equipment 116 may include trawl doors or other suitable device for providing spreading force when towed through the body of water 104. The sensor streamers 112 may each be formed, for example, by coupling a plurality of streamer segments (none shown separately). The sensor streamers 112 may be maintained in the selected pattern by towing equipment 116, such as paravanes or doors that provide lateral force to spread the sensor streamers 112 to selected lateral positions with respect to the survey vessel 102. The sensor streamers 112 may have a length, for example, in a range of from about 2,000 meters to about 12,000 meters or longer. The configurations of the sensors streamers 112 on FIG. 1 is provided to illustrate an example embodiment and is not intended to limit the present disclosure. It should be noted that, while the present example, shows four of the sensor streamers 112, the present disclosure is applicable to any number of sensor streamers 112 towed by survey vessel 102 or any other vessel. For example, in some embodiments, more or less than four of the sensor streamers 112 may be towed by survey vessel 102, and the sensor streamers 112 may be spaced apart laterally, vertically, or both laterally and vertically.

The sensor streamers 112 may include seismic sensors 114 thereon at spaced apart locations. The seismic sensors 114 may be any type of seismic sensors known in the art, including hydrophones, geophones, particle velocity sensors, particle displacement sensors, particle acceleration sensors, pressure gradient sensors, or combinations thereof, for example. By way of example, the seismic sensors 114 may generate response signals, such as electrical or optical signals, in response to detecting acoustic energy emitted from the acoustic projector 110 after the energy has interacted with the subsurface formations (not shown) below the water bottom. Signals generated by the seismic sensors 114 may be communicated to the recording system 106. While not illustrated, the seismic sensors 114 may alternatively be disposed on ocean bottom cables or subsurface acquisition nodes in addition to, or in place of, sensors streamers 112.

In accordance with example embodiments, a geophysical data product indicative of certain properties of the one or more subsurface formations (not shown) may be produced from the detected acoustic energy. The geophysical data product may include acquired and/or processed seismic data and may be stored on a non-transitory, tangible, computer-readable medium. The computer-readable medium may include any computer-readable medium that is tangible and non-transitory, including, but not limited to, volatile memory, such as random access memory (RAM) and non-volatile memory, such as read-only memory (ROM), flash memory, hard disc drives, optical disks, floppy discs, and magnetic tapes. The geophysical data product may be produced offshore (e.g., by on a vessel) or onshore (e.g., at a facility on land) either within the United States and/or in another country. Specifically, embodiments may include producing a geophysical data product from at least the measured acoustic energy and storing the geophysical data product on a non-transitory tangible computer-readable medium suitable for importing onshore. If the geophysical data product is produced offshore and/or in another country, it may be imported onshore to a facility in, for example, the United States or another country. Once onshore in, for example, the United States (or another country), further processing and/or geophysical analysis may be performed on the geophysical data product. According to some embodiments, reflected sound waves may comprise at least a portion of the first sound wave and/or the second sound wave. The sound waves that are reflected from a subsurface interface are then processed to produce a seismic image.

As illustrated in FIG. 1, the survey vessel 102 or a different vessel may further tow acoustic projector 110. Although only a single acoustic projector 110 is shown, it should be understood that more than one acoustic projector 110 may be used as desired for a particular application. Where more than one of the acoustic projector 110 is used, they may be towed by the survey vessel 102 or different survey vessels, for example. A source cable 118 may couple the acoustic projector 110 to the survey vessel 102. The source cable 118 may take drag forces and also may include electrical conductors (not shown separately) for transferring electrical current from the recording system 106 on the survey vessel 102 to the acoustic projector 110. The source cable 118 may also include signal cables or fibers for transmitting signals to and/or from the acoustic projector 110 to the recording system 106. The source cable 118 may also include strength members (not shown separately) for transmitting towing force from the survey vessel 102 to the acoustic projector 110. The source cable 118 may also contain conductors for transmitting/injecting air or another gas to the acoustic projector 110 for pressure compensation to an internal gas pressure of the interior of the acoustic projector 110, relative to external pressure, for example. The source cable 118 may have a length in a range of from about 100 meters to about 2,000 meters or longer, for example. In some embodiments, the source cable 118 may be relatively parallel to the surface of the body of water 104, while in other embodiments, the source cable 118 may utilize depth control mechanisms, for example, to locate more than one acoustic projector 110 at a plurality of different depths.

In some embodiments, the control system 108 may operate the acoustic projector 110. Those of ordinary skill in the art, with the benefit of this disclosure, should be able to select an appropriate frequency for operation of the acoustic projector 110. The control system 108 may include hardware and software that operate to control acoustic projector 110. For example, control system 108 may include a processor (e.g., microprocessor), memory, and interfaces, among other components. In some embodiments, processor may include any type of computational circuit, such as a microprocessor, a complex instruction set computing (CISC) microprocessor, a reduced instruction set computing (RISC) microprocessor, a very long instruction word (VLIW) microprocessor, a digital signal processor (DSP), or any other type of processor, processing circuit, execution unit, or computational machine. It should be understood that embodiments of the control system 108 should not be limited to the specific processors listed herein. In some embodiments, the control system 108 uses iterative learning control characterizations to control a phase, generate a repeatable signal, and reduce unwanted harmonics on an arbitrary signal.

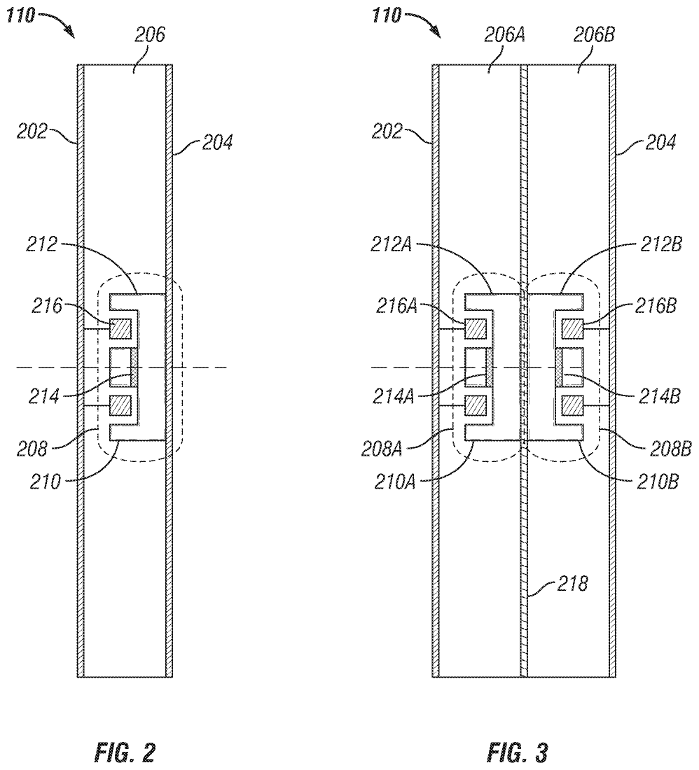

FIG. 2 illustrates an acoustic projector 110 in accordance with an example embodiment. The acoustic projector 110 shown on FIG. 2 may be used as acoustic projector 110 in the embodiment of FIG. 1. As shown, the acoustic projector 110 may include a first bender plate 202, a second bender plate 204, and a cavity 206 formed by the first and second bender plates 202 and 204. As shown, first and second bender plates 202 and 204 may be coupled together to provide an internal cavity 206 between the first and second bender plates 202 and 204. First and second bender plates 202 and 204 may also be coupled to one another in a manner that allows the first and second bender plates 202 and 204 to bend and generate the desired pressure waves. Internal cavity 206 may form a sealed volume such as vacuum cavity or be filled with fluid, such as gas and/or a liquid. In particular embodiments, the first and second bender plates 202 and 204 may be coupled to one another at their outer edges.

The first and second bender plates 202 and 204 may be based on generation of acoustic energy through mechanical vibration of a flexible disc, also referred to as a flexural disc projector. Additionally, a driver 208 may be affixed to the second bender plate 204 and disposed within the cavity 206, such that the first and second bender plates 202 and 204 can oscillate to generate an acoustic wave. As shown, the driver 208 may comprise a stator 210, an actuator 212, a permanent magnet 214, and voice coil 216. By way of example, the stator 210 may be attached to one of the bender plates (e.g., second bender plate 204) and the voice coil 216 may be attached the other of the bender plates (e.g., first bender plate 202). When current is flowed through the voice coil 216, the two parts of the actuator 212 may be attracted or repelled causing the first and second bender plates 202, 204 to bend inwards and outwards at the same time. Accordingly, embodiments may use an alternate current to generate a monopole wavefield in the surrounding medium. While not illustrated, springs and mass elements may be attached to the first and second bender plates 202 and 204 as desired for a particular application. When current is applied to driver 208, driver 208 may then apply a force to a corresponding transmission element. In some embodiments, the first and second bender plates 202 and 204 may be generally planar. In particular embodiments, the first and second bender plates 202 and 204 may each be in the form of a flexible disk. In some embodiments, the first and second bender plates 202 and 204 may each be in the form of flat, circular disks having substantially uniform thickness (i.e., disk thickness varies by no more than 10%), and include both axially-symmetric and axially-asymmetric configurations as may be suitable for particular applications.

By way of example, the first and second bender plates 202 and 204 may be rectangular, square, elliptical, or other suitable shape for providing the desired pressure waves. The first and second bender plates 202 and 204 may be made from any of a variety of materials including materials comprising metal, metal alloy, steel, aluminum, titanium, stainless steel, a copper alloy, glass-fiber reinforced plastic (e.g., glass-fiber reinforced epoxy), one or more composite materials, carbon fiber reinforced or other suitable flexible spring material. Examples of suitable copper alloys may include brass, beryllium, copper, phosphor bronze, or other suitable copper alloy. In some embodiments, the first and second bender plates 202 and 204 may comprise aluminum or be made from the same or a different material. In particular embodiments, the first and second bender plates 202 and 204 may have a thickness from about 1 millimeter to about 12 millimeters or even greater. However, dimensions outside these ranges may be suitable for a particular application, as desired by one of ordinary skill in the art with the benefit of this disclosure. In general, the first and second bender plates 202 and 204 may be configured of a thickness that allows sufficient deformation but can withstand expected differential static pressures.

It will be appreciated that, according to other embodiments of the present disclosure, acoustic energy may be generated by acoustic source via other means including a flextensional shell. While not illustrated, the flextensional shell may be formed, for example, by two shell side portions that may be mirror images of one another and operable to be driven in phase, or out of phase with respect to one another. Additionally, flextensional shell may be elliptical in shape or may be any other suitable shape, including convex, concave, flat, or a combination thereof.

While not illustrated, according to some embodiments of the disclosure, one or more of first and second bender plates 202, 204 may include a hinge to generate a secondary acoustic energy resonance output. Generation of a secondary acoustic energy output may be useful to the system output.

FIG. 3 illustrates an acoustic projector 110 in accordance with another embodiment of the present disclosure. The acoustic projector 110 shown on FIG. 3 may be used as acoustic projector 110 in the embodiment of FIG. 1. As shown, first bender plate 202 and second bender plate 204 may be coupled together by a fixed plate 218. It will be appreciated, that while fixed plate 218 is shown, first bender plate 202 and second bender plate 204 may be coupled together by any suitable fixture, such as a frame, plate, or other securing member. In the illustrated embodiment, the fixed plate 218 is disposed between the first bender plate 202 and the second bender plate 204 and may be sized to maintain a separation (e.g., a gap) between the first bender plate 202 and the second bender plate 204. A first cavity 206A may be at least partially defined by the first bender plate 202 and a first side of the fixed plate 218. A second cavity 206B may be at least partially defined by the second bender plate 204 and the opposite, or second side of the fixed plate 218. As shown the first and second cavities 206A, 206B are coupled and separated by the fixed plate 218, such that the first bender plate 202 and the second bender plate 204 are oppositely disposed from one another. As noted, first bender plate 202 and second bender plate 204 may be coupled to a first side of a fixture and a second side of a fixture, respectably.

As illustrated, a first driver 208A may be affixed to a portion of one side of the fixed plate 218 in the first cavity 206A. The first driver 208A may comprise stator 210A, permanent magnet 214A, actuator 212A, and voice coil 216A. As illustrated, a second driver 208B may be affixed to a portion on the side of the fixed plate 218 in the second cavity 206B. The second driver 208B may comprise stator 210B, permanent magnet 214B, actuator 212B, and voice coil 216B. It will be appreciated, that, while first driver 208A and second driver 208B are shown, according to other embodiments, other driver types may be used such as a bi-directional driver, in which both parts of the driver may be controlled individually. As shown, first and second drivers 208A, 208B are affixed to opposite sides of the fixed plate 218. The first and second drivers 208A, 208B of the acoustic projector 110 are operable to act upon the first bender plate 202 and the second bender plate 204 independently in response to in-phase or out-of-phase current. As shown, the first driver 208A may be coupled to the first bender plate 202, and the second driver 208B may be coupled to the second bender plate 204. It will be appreciated that current may be controlled in a number of ways including in response to signal communication from one or more sources such as control system 108 as shown and described with respect to FIG. 1. For example, first and second drivers 208A, 208B may comprise electromagnetic parts which may comprise permanent magnetic material mounted on either side of the fixed plate 218. While FIG. 3 illustrates separate electromagnetic parts, the first and second drivers 208A, 208B may be coupled to corresponding spring elements. Additionally, it will be appreciated that the first and second drivers 208A, 208B may also include one or more piezoelectric elements.

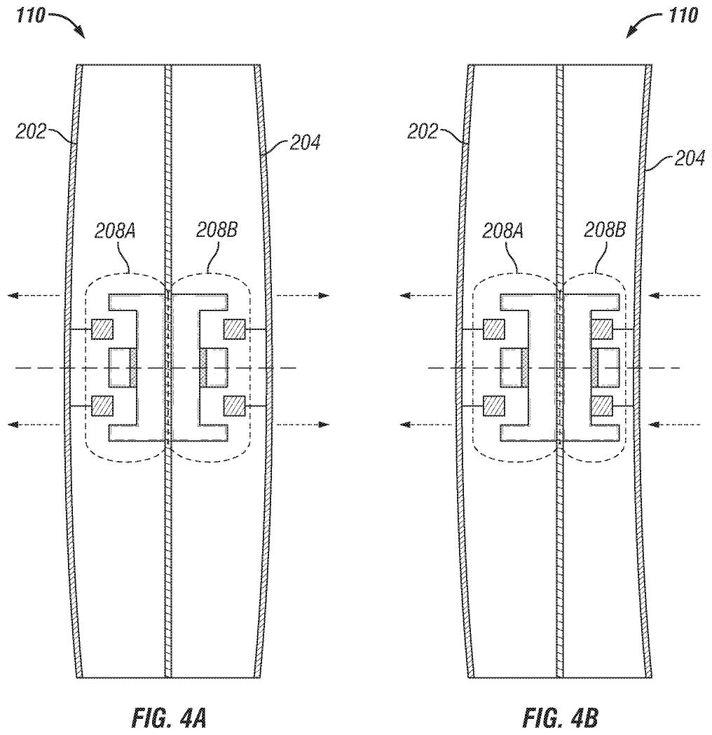

FIG. 4A illustrates an example embodiment of generation of acoustic waves by an acoustic projector 110 operating in a first mode. In the illustrated embodiment, the acoustic projector 110 is generating a monopole sound wave in response to the first and second drivers 208A, 208B each receiving current that is in phase. When the current is in phase, first and second drivers 208A, 208B may cause the first bender plate 202 and the second bender plate 204 to flex outward as shown. The first and second drivers 208A, 208B, for example, may be operated to flex outward and then inward or alternatively, inward and then outward. Since the first bender plate 202 and the second bender plate 204 are on opposite sides of the acoustic projector 110, both may flex outward and produce a monopole sound wave. By way of example, to control a mode of operation (monopole/dipole), control system 108 may be in signal communication with the first driver 208A and the second driver 208B, wherein the control system 108 is operable to provide in phase current to the respective voice coils 216A, 216B of the first driver 208A and the second driver 208B for monopole operation and is also operable to provide out of phase current to the respective voice coils 216A, 216B of the first driver 208A and the second driver 208B for dipole operation. In some embodiments, first sound wave and the second sound wave generate a dipole sound wave with a frequency in a range of from about 0.1 Hz to about 6 Hz.

FIG. 4B illustrates another example embodiment of generation of acoustic waves by an acoustic projector 110 operating in a second mode. In the illustrated embodiment, the acoustic projector 110 is generating a dipole sound wave in response to the first driver 208A receiving a current in one phase and the second driver 208B receiving a current that is out of phase with respect to the current supplied to the first driver 208A. When the current is out of phase, first driver 208A may cause the first bender plate 202 to flex outward, and the second driver 208B may cause the second bender plate 204 to flex inward. Since the first bender plate 202 and the second bender plate 204 are on opposite sides of the acoustic projector 110, the combination of an outward flex on the first bender plate 202 and an inward flex on the second bender plate 204 or, alternatively, an inward flex on the first bender plate 202 and an outward flex on the second bender plate 204 produces a dipole sound wave, where the seismic emanations result in an up-going wave and a down-going wave with opposite polarity.

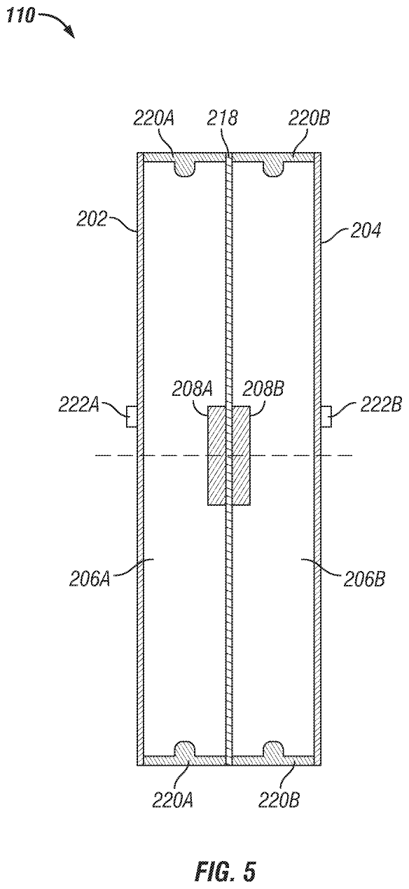

FIG. 5 illustrates an acoustic projector 110 in accordance with another embodiment of the present disclosure. The acoustic projector shown on FIG. 5 may be used as acoustic projector 110 in the embodiment of FIG. 1. As shown, the first bender plate 202 and the second bender plate 204 may be coupled together by a fixed plate 218. In the illustrated embodiment, the fixed plate 218 is disposed between the first bender plate 202 and the second bender plate 204 and may be sized to maintain a separation (e.g., a gap) between the first bender plate 202 and the second bender plate 204. A first cavity 206A may be at least partially defined by the first bender plate 202 and one side of the fixed plate 218. A second cavity 206B may be at least partially defined by the second bender plate 204 and the opposite side of the fixed plate 218. As shown the first and second cavities 206A, 206B are coupled and separated by the fixed plate 218, such that the first bender plate 202 and the second bender plate 204 are oppositely disposed from one another.

As illustrated, a first driver 208A may be affixed to a portion of one side of the fixed plate 218 in the first cavity 206A. As illustrated, a second driver 208B may be affixed to a portion on the side of the fixed plate 218 in the second cavity 206B. As shown, first and second drivers 208A, 208B are affixed to opposite sides of the fixed plate 218. The first and second drivers 208A, 208B of the acoustic projector 110 are operable to act upon the first bender plate 202 and the second bender plate 204 independently in response to in-phase or out-of-phase current. As shown, the first driver 208A may be coupled to the first bender plate 202, and the second driver 208B may be coupled to the second bender plate 204. It will be appreciated that current may be controlled in a number of ways including in response to a signal from one or more sources such as control system 108 as described with respect to FIG. 1. The first and second drivers 208A, 208B may include a linear drive, which may also include an electro-dynamic actuator. In some embodiments, the first and second drivers 208A, 208B may be a moving coil or voice coil actuator. Projector sources using one or more moving coil actuators may be referred to as moving coil projectors. While FIG. 5 shows the first and second drivers 208A, 208B as single, bi-directional linear actuator, embodiments with one or more uni-directional drivers in which a plurality of actuators are used in parallel are within the scope of the present disclosure.

As shown, each cavity 206A, 206B also features one or more endcaps 220A, 220B. Endcaps 220A, 220B may seal one or more ends of fixed plate 218 and the first and second bender plates 202, 204 to form cavities 206A, 206B. While acoustic projector 110 is shown with endcaps 220A, 220B, according to alternate embodiments, each cavity 206A, 206B does not require endcaps. With additional reference to FIG. 5, the base plates 202, 204 may be secured to fixed plate 218 in a manner that allows the first and second bender plates 202, 204 to bend and create the desired acoustic energy. In particular embodiments, the first and second bender plates 202, 204 may be coupled to fixed plate 218 at their outer edges. As illustrated, the acoustic projector 110 may further comprise one or more endcaps 220A, 220B, for example, that couples the first and second bender plates 202, 204 to the fixed plate 218 one or more outer edges. In the illustrated embodiment, endcaps 220A, 220B may include an inner extension that couples the edges of the first and second bender plates 202, 204. The endcaps 220A, 220B may be coupled to the first and second bender plates 202, 204 and fixed plate 218 by soldering or other suitable coupling technique, such as use of an adhesive or fasteners (e.g., screws). While the endcaps 220A, 220B are shown for securing the first and second bender plates 202, 204 to fixed plate 218, other suitable techniques may be used to secure the first and second bender plates 202, 204. For example, the first and second bender plates 202, 204 may be configured so that the outer edges overlap without the need for endcaps 220A, 220B.

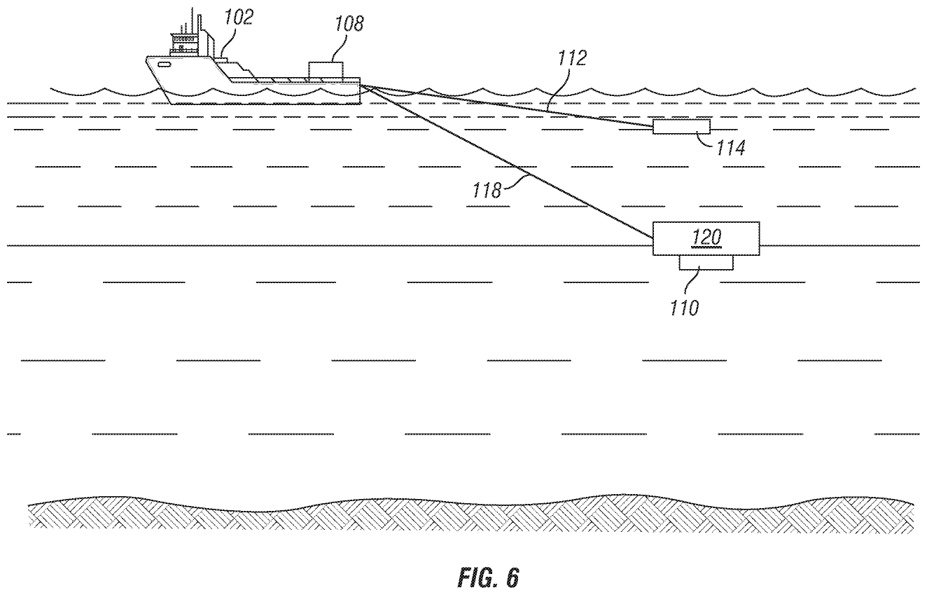

In some embodiments, the acoustic projector 110 may further include first and second sensors 222A, 222B. A first sensor 222A may be placed on or coupled to the first bender plate 202. A second sensor 222B may be placed on or coupled to the second bender plate 204. The first and second sensors 222A, 222B may be any type of particle motion sensor, for example geophones or accelerometers. First and second sensors 222A, 222B may be used for a control feedback loop to control the operation each bender plate 202, 204 of the acoustic projector 110 via interaction with control system 108 as shown in FIG. 1. In another example the first sensor 222A may be a hydrophone or other type of pressure or pressure time gradient sensors and the second sensor 222B may be a particle motion responsive device such as an accelerometer. In other examples, more than two sensors may be used to measure the response of the acoustic projector 110 at other selected positions. While the first and second sensors 222A, 222B are shown coupled to the first and second bender plates 202, 204, it will be appreciated that the first and second sensors 222A, 222B may alternatively be coupled to one or more portions of a tow sled as discussed with respect to FIG. 6.

While not illustrated, electrical connections may be made to the acoustic projector 110 and components thereof, including the first and drivers 208A, 208B via cable 118 as shown in FIG. 1. For example, an electrical connection may be made to each of the first and second drivers 208A, 208B, and another electrical connection may be made to each of the first and second sensors 222A, 222B. Current may be applied across the electrical connections so that the applied electrical field results in a mechanical strain in the first and second drivers 208A, 208B with resultant bending and flexing of the first and second base plates 202, 204 to generate acoustic energy.

FIG. 6 illustrates a side view of a marine survey system including an acoustic projector sled 120. While only one acoustic projector sled 120 is illustrated in FIG. 6, more than one may be used in various configurations, including an array. Marine survey vessel 102 may tow the acoustic projector sled 120 via cable 118. Cable 118 may house power and communication lines to transfer electrical energy and provide digital communication between source sled 120 and marine survey vessel 102. For example, source sled 120 may use a fluid, such as air, for pressure compensation, which may be transferred through cable 118 from the marine survey vessel 102, which may be an umbilical. For example, cable 118 may be in fluid communication with a gas source for pressure compensation on marine survey vessel 102. Marine survey vessel 102 may include a control system 108 as described with respect to FIG. 1. Additionally, source sled 120 may support acoustic projector 110 as shown. Additionally, shown are streamer 112 and sensor 114, as shown and described with respect to FIG. 1.

The particular embodiments disclosed above are illustrative only, as the described embodiments may be modified and practiced in different but equivalent manners apparent to those skilled in the art having the benefit of the teachings herein. Although individual embodiments are discussed, the disclosure covers all combinations of all those embodiments. Furthermore, no limitations are intended to the details of construction or design herein shown, other than as described in the claims below. It is therefore evident that the particular illustrative embodiments disclosed above may be altered or modified and all such variations are considered within the scope and spirit of the present disclosure. All numbers and ranges disclosed above may vary by some amount. Whenever a numerical range with a lower limit and an upper limit is disclosed, any number and any included range falling within the range are specifically disclosed. Moreover, the indefinite articles “a” or “an,” as used in the claims, are defined herein to mean one or more than one of the elements that it introduces. Also, the terms in the claims have their plain, ordinary meaning unless otherwise explicitly and clearly defined by the patentee. Furthermore, the word “may” is used throughout this application in a permissive sense (i.e., having the potential to, being able to), not in a mandatory sense (i.e., must). The term “include,” and derivations thereof, mean “including, but not limited to.” The term “coupled” means directly or indirectly connected. If there is any conflict in the usages of a word or term in this specification and one or more patent or other documents that may be incorporated herein by reference, the definitions that are consistent with this specification should be adopted for the purposes of understanding this disclosure.

What is claimed is:

1. An acoustic projector comprising:
a fixed plate;
a first bender plate coupled to a first side of the fixed plate;
a second bender plate coupled to a second side of the fixed plate, opposite to the first side;
a first driver coupled to the first side of the fixed plate and to the first bender plate to oscillate the first bender plate; and
a second driver coupled to the second side of the fixed plate and to the second bender plate to oscillate the second bender plate.

2. The acoustic projector of claim 1, further comprising a control system in signal communication with the first driver and the second driver, wherein the control system is operable to provide in-phase current to respective voice coils of the first driver and the second driver for monopole operation and is also operable to provide out-of-phase current to the respective coils of the first driver and the second driver for dipole operation.

3. The acoustic projector of claim 1, further comprising a control system operable to cause the first driver and the second driver to operate independently.

4. The acoustic projector of claim 1, wherein the fixed plate separates a first cavity in the acoustic projector from a second cavity in the acoustic projector, wherein the first cavity and the second cavity are sealed from one another, and wherein the first driver is disposed in the first cavity and the second driver is disposed in the second cavity.

5. The acoustic projector of claim 4, further comprising a pressure compensation system that comprises a gas source in fluid communication with at least one of the first cavity and/or the second cavity.

6. The acoustic projector of claim 1, wherein the first driver and second driver each comprise a linear drive that comprises a permanent magnet and a voice coil, each voice coil being attached to the respective first bender plate or the second bender plate by a corresponding transmission element.

7. The acoustic projector of claim 1, wherein the first bender plate and the second bender plate each comprise a material including one or more of: metal, metal alloy, steel, aluminum, titanium, stainless steel, copper alloy, glass-fiber reinforced plastic, carbon fiber, or composite material.

8. The acoustic projector of claim 1, wherein the first bender plate and the second bender plate each have a hinge to generate a secondary acoustic energy resonance output.

9. The acoustic projector of claim 1, further comprising endcaps on each end of the first bender plate and the second bender plate and that form a sealed volume with the first bender plate and the second bender plate.

10. A method for marine seismic surveying, comprising:
towing an acoustic projector through a body of water, wherein the acoustic projector comprises:
a fixture;
a first bender plate attached to a first side of the fixture;
a second bender plate attached to a second side of the fixture, opposite to the first side;
a first driver attached to the first side of the fixture and to the first bender plate; and
a second driver attached to the second side of the fixture and to the second bender plate;
actuating the first driver to cause the first bender plate to flex to generate a first sound wave emanating from the acoustic projector; and
actuating the second driver to cause the second bender plate to flex to generate a second sound wave emanating from the acoustic projector.

11. The method of claim 10, wherein the actuating the first driver and the actuating the second driver comprises sending in-phase current to the first driver and the second driver such that the first sound wave and the second sound wave in phase with one another.

12. The method of claim 10, wherein the actuating the first driver and the actuating the second driver comprises sending out-of-phase current to the first driver and the second driver such that the first sound wave and the second sound wave are about 180° out of phase with one another.

13. The method of claim 12, wherein the first sound wave and the second sound wave generate a dipole sound wave with a frequency in a range of from about 0.1 Hz to about 6 Hz.

14. The method of claim 10, further comprising injecting a gas into an interior of the acoustic projector for equalization an internal gas pressure of the acoustic projector with an external pressure.

15. The method of claim 11, further comprising: obtaining geophysical data from measurements of reflected sounds waves, wherein the reflected sound waves comprise at least a portion of the first sound wave and/or the second sound wave that are reflected from a subsurface interface; processing the geophysical data to produce a seismic image; and recording the seismic image on a non-transitory, tangible computer-readable medium, thereby creating a geophysical data product.

16. A method of operating an acoustic projector, comprising:
selecting a mode of operation for the acoustic projector, wherein the mode is selected from at least one of monopole operation or dipole operation, wherein the acoustic projector comprises, a first bender plate, a second bender plate, a first driver attached to the first bender late, and a second driver attached to the second bender plate;
sending current to the first driver and the second driver to implement the selected mode of operation; and
flexing the first bender plate with the first driver to generate a first sound wave; and
flexing the second bender plate with the second driver to generate a second sound wave.

17. The method of claim 16, wherein the selected mode operation is monopole operation, and wherein the first sound wave and the second sound wave in phase with one another.

18. The method of claim 16, wherein the selected mode operation is dipole operation, and wherein the first sound wave and the second sound wave are about 180° out of phase with one another.

19. The method of claim 16, further comprising changing the mode of operation, wherein the changing the mode of operation either comprising changing from the monopole operation to the dipole operation or changing from the dipole operation to the monopole operation.

20. The method of claim 16, further comprising towing the acoustic projector in a body of water.
